(19) United States
(12) Patent Application Publication
(10) Pub. No.: US 2004/0129731 A1
(43) Pub. Date: Jul. 8, 2004

(54) Divot filling device and method

(76) Inventor: Donald Hahn, Santa Barbara, CA (US)

Correspondence Address: Daniel J. Meaney, Jr., Post Office Box 22307, Santa Barbara, CA, 93121, US

(21) Appl. No.: 10/336,507

(22) Filed: Jan. 3, 2003

(51) Int. Cl. B67D 5/64; B67C 11/00

(52) U.S. Cl. 222/175; 222/462; 222/567

(57) ABSTRACT

A portable device for dispensing a quantity of filling material is shown. The portable device includes a first generally extended housing defining a cavity of a selected volume for confining a quantity of dispensable filling material. The housing includes a top member having a curvilinear extending member for defining a dispensing passageway including a first end and a second end. The first end is structured to communicate with the cavity and the second end is structured to define a dispensing opening positioned in a predetermined position relative to the cavity. As such, displacement of the housing in a first direction urges the dispensing passageway into a dispensing position wherein a portion of a quantity of filling material confined in the cavity is capable of being transported through the dispensing passageway and out of the dispensing opening to fill and repair a divot. Displacement of the housing in a second direction urges the dispensing passageway into a storage position wherein a quantity of filling material is confined in the cavity. A method and system for repairing a divot is also shown.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX” (SEE 37 CFR 1.96)

Not Applicable

### BACKGROUND OF THE INVENTION

1. Field of the Invention

This invention is directed to the field of portable devices or containers, generally, and more particularly to a portable device or container is configured for transporting and dispensing a quantity of filling material, e.g. sand, grass seed and the like, to be used by golfer for repairing a divot made by a golfer during a game of golf.

2. Description of the Prior Art

Golf Courses continually strive to keep their fairways in the best possible playing condition throughout playing season, be it year round or seasonally. One of the material problems encountered in maintaining good fairways has been the problem of golfers causing divots during play.

As is known in the art, a divot is a piece of turf gouged out of the fairway or other portion of a golf course made by a golfer swinging a golf club when making a stroke, drive or play and physically hitting the turf on some golf courses, particularly a par three course, an iron golf club is typically used for making a shot, stroke or drive. The golf course typically provides, at selected locations intermediate the course traversed during the play of golf, a fixed receptacle containing sand and with a hand scoop. The sand and scoop are to be used by the golfer to immediately fill in the divot made by the golfer while hitting or driving the ball.

It is very frustrating for a golfer to drive a ball onto a fairway and then to have the ball come to rest in an unrepaired divot. In order to overcome this problem, golf courses are encouraging golfers to immediately repair divots during play to minimize the problems caused by divots.

Typically, a golfer takes a practice swing before attempting each shot, drive or stroke, i.e. a practice attempt before actually driving a golf ball, typically at a location near or on a driving tee on each golf course hole. Each practice swing taken by a golfer has the potential for making a divot. Most of the golfers on golf courses require several shots, stokes or drives to reach the green of each hole in regulation play or in accordance with the number of drives allocated to or designated as “par” for a designated hole. It is not uncommon for golfers on the golf course to make more shots, drives or strokes in excess of the regulation play or “par” posted for the applicable hole. This increases the probability of a golfer making an increased number of divots in a course during golf play.

Generally, that portion of the fairway extending from about 20 yards out from the green up to 100 yards out from the green, which generally comprise adjacent green areas, are subject to a large number of divots. One reason is that a golfer typically uses shorter clubs, such as for example a wedge, to drive the ball on to the green and into position for final putting of the ball into a cup using a putter.

Typically, divots formed by golfers in the adjacent green areas, as discussed above, are not repaired. This is due primarily to the fact that the adjacent green areas are close to the green. After or between a shot, drive or stroke of a ball placing a ball onto the green, golfers typically do not go back to a cart to retrieve a putter and usually carry the putter on their person to complete hole play. As a result, the golfer does not typically carry a container or bottle having material for repairing divots in the adjacent green area.

During certain parts of the golf-playing season, the weather conditions are such that a golf course does not permit the use of carts on the course due to potential damage that could be caused by a cart to the fairways and greens. In such instances, play is restricted to golfers walking the course. In such instances, the golfer carries the golf clubs or uses a push-pull golf cart for transporting of golf clubs over the golf course during play. In these instances, unless containers or bottles containing material for filling divots are located on or attached to a golf cart, the containers or bottles are not readily available to a typical golfer for repairing divots.

In the recent past, golf courses have become active in developing divot repair programs to encourage golfers to use golf course supplied materials for making divot repairs.

Certain of the divot repair programs are used on a golf course having a “Carts Only” rule. The program includes providing on an electric or small gasoline engine driven Cart or removeably attaching to an electric or small gasoline engine driven Cart a generic bottle having material for repairing divots which is used by the golfer to fill divots. The success of such a program resides in urging a golfer to use the generic bottle available in the electric or small gasoline engine driven Cart or attached to the an electric or small gasoline engine driven Cart to dispense material to immediately repair a divot made by the golfer.

Certain of the divot repair programs are used on a golf course having a “Cart Paths Only” rule. On such golf courses, the an electric or small gasoline engine driven Cart, having the generic container having materials for filling divots, must remain on the established and designated cart paths. Typically, the golfer stops the electric or small gasoline engine driven Cart on the designated path, which is remote from the point of play, selects one or more golf clubs for the next play, stroke or drive and walks to the point of play. Unfortunately and in most instances, the golfer forgets to take or elects not to take the generic container having the material for repairing divots to the location or point of play where the shot, drive or play is to be played.

Generally, a significant number of golfers do not take the generic container having materials for filling divots to the location of the play. As a result, a shot, drive or stroke is taken, resulting in some of the drives making a divot. In such instances, it is up to the golfer to make an attempt to at least replace the divot if a sufficient portion of the divot is still in tact. In a majority of instances, the divot has been substantially disintegrated or otherwise broken into several pieces making divot replacement difficult, if not impossible.

As a result, an unsightly and unrepaired divot is generated. Typically, a fairway will need several days, if not weeks, for the turf in an unrepaired divot to re-grow back, without the aid of a dispensed growing supplement, in order to mitigate or overcome the damage to the fairway caused by the divot.

It is known in the prior art to provide containers having a dispensing opening for carrying a variety of contents available for use during golf play including materials for repairing divots during golf play. The following known prior art is typical of the known prior art containers.

U.S. Pat. No. 5,597,087 discloses a sports bottle for holding liquid wherein the bottle has a fill opening disposed at an angle relative to its circumferential wall and include a movable cap for the fill opening and a hook for attaching the bottle to a holder.

U.S. Pat. No. 5,484,128 discloses a beverage retaining apparatus having a bottle mounting projection and a bottle having a projection receiving channel to receive the bottle mounting projection for attaching the bottle to a push-pull golf cart.

U.S. Pat. No. 5,105,958 discloses a water bottle and support assembly for a golf bag. A bracket having a groove is mounted onto a golf bag and the water bottle has a tongue to be removable inserted into the groove to mount the bottle on a cart.

U.S. Pat. No. 4,955,572 discloses a sports bottle for holding liquid which includes an integral neck and a cap which fits on the neck to hold the sports bottle in a vertical position. The sports bottle includes a mounting tab which enables a user to place the bottle by means of the mounting tab over a belt.

U.S. Pat. No. 3,338,482 discloses a dispensing bottle having a pouring spout which is attached to the top of a liquid container and which is utilized to control the flow of liquid from the container. The spout is deflected at an angle at its dispensing end.

U.S. Pat. No. 1,459,485 discloses a pouring spout which is capable of being inserted into a container containing a liquid wherein the pouring spout functions as an emptying device to facilitate rapid dispensing of a liquid from the container through the pouring spout. An air passage included in the spout facilitates rapid displacement of the fluid upon inversion of a container having the spout located therein.

DES 413,798 discloses ornamental design for a bottle having a pouring spout disposed at an angle relative to the central axis of the bottle and a dispensing handle.

DES 336,429 discloses a combined closure and pouring spout device adapted to be attached to a container for dispensing material therefrom.

EPO 058 208 A1 discloses a hand held sand dispenser comprising a plastic container with a handle and a rotary dispenser closure. The dispenser scatters sand over surfaces after manual opening of the rotary closure and inversion of the container to make a surface non-slippery for driving or walking.

U.S. Pat. No. 5,131,570 discloses a seed-dispensing device for repairing divots on a golf course. The device includes a container having an elongated tubular housing, a lower dispensing opening and spring-loaded dispensing rod.

U.S. Pat. No. 6,267,269 discloses a portable receptacle to be carried by a golfer to repair and restore divot marks by dispensing sand and related granular material on the golf course. The receptacle comprises a canister housing and an axially movable spring biased member.

A generic container for dispensing materials for filling divots during a golf game is sold under the KADDY LAC brand. The generic container has an angled “V” shaped hook to place the container of a golf cart. The generic container forms part of a divot replacement supply system having, on a storage rack or cart, refillable generic bottles. The generic bottle includes an elongated tapered pouring spout having a dispensing opening substantially perpendicular to the spout for dispensing granular material for replacing divots.

The prior art does not anticipate, suggest, disclose or teach the present invention of a portable device or container for filling material for repairing divots during a golf game as disclosed herein.

### BRIEF SUMMARY OF THE INVENTION

The present invention overcomes the problems associated with the prior art including use of a new, novel and unique container for confining filling material in a cavity in a housing for repairing divots and which are configured so as to be readily available to a golfer at the appropriate time to encourage a golfer to immediately repair a divot.

The present invention discloses and teaches a portable device or container for dispensing a quantity of filling material for repairing divots during a golf game. In the preferred embodiment, the portable device comprises a first generally extended housing for defining a cavity of a selected volume for confining a quantity of filling material therein. The housing including a top member having a curvilinear extending member, preferably in the form of a curvilinear dispensing spout, which is cambered relative to the cavity for defining a dispensing passageway including a first end and a second end. The first end is configured to communicate with the cavity. The second end is structured to define a dispensing opening which is canted relative to the curvilinear extending member. As such, displacement of the housing in a first direction urges the dispensing passageway into a dispensing position wherein a portion of a quantity of filling material confined in the cavity is capable of being transported through the dispensing passageway and out of the dispensing opening into a divot. Displacement of the housing in a second direction urges the dispensing passageway into a storage position wherein the quantity of filling material is confined in the cavity.

Thus, one advantage of the present invention is that the portable device or container having filling material, preferably a granular filling material, for repairing divots is configured to comprise a housing having an attaching member, preferably in the form of a clip retaining member, which permits a golfer to attach the container to the golfer's cart including an electric or small gasoline engine driven Cart, collectively referred to herein as the golf cart, the golfer's golf bag or to the person of the golfer, e.g. to the golfer's belt. In such instances, when the golfer makes a divot, a container containing the filling material for repairing the divot is readily available such that the golfer can easily remove the container from the golf cart, golf bag or the person of a golfer, e.g. a golfer's belt, waist band of the like, and immediately repair the divot.

Another advantage of the present invention is that the container for filling material for repairing a divot has a housing which defines a cavity for confining the filling material within the cavity when the container is attached to a golf cart, golf bag or to the person of a golfer. The top section of the container housing defines a curvilinear extending member, e.g. a curvilinear dispensing spout, which terminates in a canted dispensing opening which enables a golfer to raise the bottom of the housing above the curvilinear dispensing spout to transport the filling material from the cavity within the housing, through the curvilinear dispensing spout and dispensing opening on to the divot repairing the same. When an appropriate volume or quantity of filling material has been dispensed by the golfer into the divot repairing the same, the golfer transports the bottom below the curvilinear dispensing spout causing the filling material to return to and be confined in the cavity of the housing. The golfer then reattaches the container to the golf cart, golf bag or to the person of a golfer.

Another advantage of the present invention is that the container is configured to be easily attached to and be removed from a golf cart, golf bag or the person of a golf which facilitates the ease of a golfer using the container to fill divots promptly after a golfer makes the same.

Another advantage of the present invention is that the container can contain filling material in the cavity of the housing for repairing approximately 8 to 10 divot repairs. As such, the golfer is able to immediately repair all divots made by the golfer due to the fact that sufficient quantity of filling material is stored and confined in the container. This enables a typical golfer to repair all divots made during a typical game of golf which generally comprises 18 holes of play.

Another advantage of the container of the present invention is that if the golfer utilizes a substantial portion of the filling material for repairing divots during play, which is typical of less experienced golfers, the golf course may have positioned, at selected intermediate locations traversed by a golfer on the golf course, filling stations containing filling material to facilitate a golfer replenishing the filling material in the container housing.

Another advantage of the present invention is that the container for dispensing filling material, preferably in the form of a granular filling material, for repairing divots can be fabricated in the preferred embodiment as an integral unit and the curvilinear dispensing spout is configured and of sufficient rigidity to function as a scoop enabling the dispensing opening to be urged into the supply of filling material to transport the filling material into and through the curvilinear dispensing spout such that when the golfer rotates the bottom below the dispensing opening the filling material is transported from the curvilinear dispensing spout into the cavity of the housing.

Another advantage of the present invention is that the container can be fabricated with a top section and a bottom section which are pivotally joined together at a pivot on one side and which has a removable latching member on an opposite side to permit the golfer to unlatch the top section from the bottom section exposing the cavity of the housing for filling. The golfer or user can then fill the cavity with appropriate quantity of filling material and then move the top section and bottom section together to a closed and latching position to confine the filling material within the cavity of the housing.

Another advantage of the present invention is that the container can have a separate housing section and a separate removable bottom planar section having latching members located on each side of the bottom for cooperating and latching the bottom planar section to the outer side wall of the housing defining the cavity. The golfer or user can remove the bottom planar section from its closed position by unlatching the same thereby exposing the cavity. The golfer or user can then fill the cavity with appropriate quantity of filling material and then reinsert the bottom planar section into the housing section causing the latching members to latch and hold the bottom planar section to the housing section in a closed position confining the filling material with the other walls of the cavity if the housing.

Another advantage of the present invention is that a golf course can provide a divot repair system and method based on using the new, novel and unique container, portable device or apparatus for repairing divots of the present invention for confining filling material in the cavity of a housing defining the container for repairing divots. The system would include filling one or more of the containers of the present invention with filling materials prior to commencement of play. The filled containers are then provided to the golfers so that the golfer can attach the same to a golf cart, golf bag or to the person of a golfer, e.g. to a golfer's belt. During play, if a golfer makes a divot, the golfer has the container readily available for using the filling material confined within the cavity of the housing of the container for immediately repairing the divot.

Another advantage of the present invention is that a golf course can provide, at several selected intermediate locations, such as, for example, three or four locations distributed throughout the golf course, filling stations containing the filling material selected by the golf course for repairing divots. As a golfer passes by a filling material station, the golfer has the ability to easily replenish the supply of filling material in the housing of the container from the source of filling material at the filling station. Upon completion of play, the container can be placed into a receiving receptacle, such as, at the end of the 18th green, enabling the golf course to retrieve the containers, replenish the quantity of filling material stored therein and replace the filled containers in a location where the filled containers can be pick-up by a golfer prior to commencing golf play. In this manner, the containers are constantly recycled, are readily available for use by a golfer and are configured such that the filled container is easily removeably attached to a golf cart, golf bag or to the person of a golfer. As such, the container is with the golfer during most of the golf game and is readily available to the golfer, at the time of making a divot, for immediately repairing the divots made during golf play.

Another advantage of the present convention is that the container for filling material for repairing divots is relatively inexpensive such that most golf courses, including both public and private courses, would find that the purchase and use of the containers and filling material economical and beneficial.

Another advantage of the present invention is that the use of a container of the present invention including the establishment, maintaining and supervision of use of a divot repair system using the containers is less labor intensive then the labor required for the golf course to repair unrepaired divots. This would help reduce the problems of unrepaired divots being present on a golf course which generally results where golfers are not encouraged or provided with the ability to immediately repair divots promptly after the golfer makes a divot. In addition, by using the teachings of this invention, golf courses could eliminate adding extra employee hours which would other be required where employees are assigned to monitor use of and to continually fill containers for use by golfers. This is typically required when prior art or generic containers or bottles having filling material are used for filling divots using containers or bottled which typically are placed in an electric or small gasoline engine driven Cart.

Another advantage of the present invention is that the containers for containing filling material for repairing divots can have graphic indicia, logos, trademarks or other visible messages affixed to the exterior surface of the outer walls of the container housing. A golf course could use such a container to its advantage for advertising and other purposes.

### BRIEF DESCRIPTION OF THE DRAWING

The present invention will become more fully understood from the following detailed description of a preferred but non limiting embodiment thereof, described in connection with the accompanying drawings, wherein:

FIG. 1 is a front, left side and top perspective view of a container having a housing for confining filling material for repairing divots on a golf course wherein the top has a curvilinear extending member for defining a dispensing opening for transporting the filling material through a dispensing opening to repair a divot and the housing has a clip holding member operatively connected thereto;

FIG. 2 is a back, bottom and right side perspective view of the container of FIG. 1;

FIG. 3 is a front elevational view of the container of FIG. 1;

FIG. 4 is a right side elevational view of the container of FIG. 1;

FIG. 5 is a top plan view of the container of FIG. 1;

FIG. 6 is a bottom plan view of the container of FIG. 1;

FIG. 7 is a left side plan view of the container of FIG. 1;

FIG. 8 is a back plan view of the container of FIG. 1;

FIG. 9 is a left side elevational view of another embodiment of a container for confining filling material for repairing divots on a golf course wherein the top member having a curvilinear extending member for defining a dispensing opening and wherein the top member is removable connected to a bottom member of the housing which defines a cavity of a selected volume for confining and storing a quantity of filling material;

FIG. 10 is a left side elevational view of the embodiment of a container of FIG. 9 wherein the top member having the curvilinear extending member for defining a dispensing opening is depicted in a separated or open position relative to and from a bottom member of the housing;

FIG. 11 is a pictorial representation of a biased connecting member shown in FIG. 9 for removeably connecting the top member having a curvilinear extending member for defining a dispensing opening communicating with that portion of the housing defining a cavity of a selected volume for confining and storing a quantity of filling material;

FIG. 12 is a pictorial representation of the biased connecting member shown in FIG. 11 with the top section is in connecting engagement with the outer wall of the bottom section of the housing defining a cavity of a selected volume for confining a quantity of filling material and with the disengaging position of the top member shown by dashed lines;

FIG. 13 is yet another embodiment of a container for dispensing filling material for repairing divots on a golf course wherein the housing has a top section and a bottom section which are pivotally connected to rotate about a pivot from a closed position to an open position to provide access to and for filling the cavity with filling material and wherein the top section and bottom section are moved back into its closed position to move a latching member into its latched closed position to confine the filling material in the cavity;

FIG. 14 is still yet another embodiment of a container for dispensing filling material for repairing divots on a golf course wherein the container housing has a bottom section which is pivotally connected to rotate about a pivot from a closed position to an open position to provide access to and for filling the cavity with filling material and wherein the bottom section is moved back into its closed position to move a latching member into its latched position to confine the filling material in the cavity;

FIG. 15 is yet still another embodiment of a container for dispensing filling material for repairing divots on a golf course wherein the housing has a separate bottom planar section which is unlatched on two sides to remove the separate bottom planar section from a closed position to an open position to provide access to and for filling the cavity with filling material and wherein the separate bottom planar section is moved back into its closed position to move the latching members into their latched closed position to confine the filling material in the cavity;

FIG. 16 is a diagrammatic representation of a container housing having a single element clip holding member operatively connected with connecting members to the upper portion of the back side of a container housing;

FIG. 17 is a diagrammatic representation of a container having a dual element clip holding member operatively connected to the upper portion of the back side of a container;

FIG. 18 is a diagrammatic representation of a container housing having a single, wide element clip holding member operatively connected to the upper portion of the back side of the housing forming the container housing;

FIG. 19 is still yet another embodiment of a container housing for filling material for repairing divots on a golf course wherein the housing has a circumferential slot formed therein for receiving a shaped elongated support having a clip holding member;

FIG. 20 is front elevational view of the housing of the container shown in FIG. 19 illustrating the circumferential slot formed in the outer wall of the housing;

FIG. 21 is right side elevational view of the housing of the container shown in FIG. 20 and a biased connecting member formed therein;

FIG. 22 is a front, top and right side perspective view of a shaped elongated support having a clip holding member configured to be inserted into the circumferential slot depicted in FIGS. 20 and 21; and

FIG. 22 is pictorial representation of a biased connecting member taken along section lines 23-23 of FIG. 21 illustrating the relationship between the biased connecting member and the circumferential slot shown in FIG. 21.

### DESCRIPTION OF THE INVENTION

### Background

This invention relates to a new, novel and unique portable receptacle, container or apparatus for a filling material for repairing divots on a golf course, such as may be used by a golfer in filling divots during a golf game. The filling material, in the preferred embodiment, may comprises a blend or composition of sand, grass seed and a soil supplement. However, it is envisioned that the housing forming the container may contain any appropriate granular filling material selected by a golf course or golfer which is suitable for filling divots during a game of golf. The term “filling material” is intended to include, cover or encompass any form, type or combination of materials suitable for filling divots and which are capable of filling divots, capable of being stored or confined in the cavity of a housing of a container and capable of being dispensed therefrom by a golfer for filling divots during play.

In the preferred embodiment the container is an integral device having a housing to which an attaching member is operatively connected, preferably on the back thereof. The attaching member is structured to be rigidly attached to the container housing, which housing of the container or portable device is filled with, stores and confines a quantity of filling material therein. The attaching member enables a housing having a filling material to be readily removeably mounted onto a golf cart, a golf bag or to the person of the golfer, such as for example, removeably attached to a golfer's belt. When the container is so removeably mounted onto a golf cart, a golf bag or to the person of the golfer, the housing is oriented in a stored, essentially upright position, confining the filling material within a cavity of the housing forming the container, portable device or apparatus.

In another embodiment, the back of the housing is configured to be arcuate shaped and has an attaching member, preferably in the form of a clip member or spring-loaded type member, to facilitate attachment of the arcuate shaped back to the golf cart, golf bag or to the person of a golfer. For example, a golf bag is generally circular shaped and an arcuate shaped back on a container housing would facilitate easy mounting and removal of the container, portable device or apparatus from a golf bag.

### Description

The device hereof will now be described with regard to the accompanying drawings, where like reference numerals represent like components or features throughout the several views.

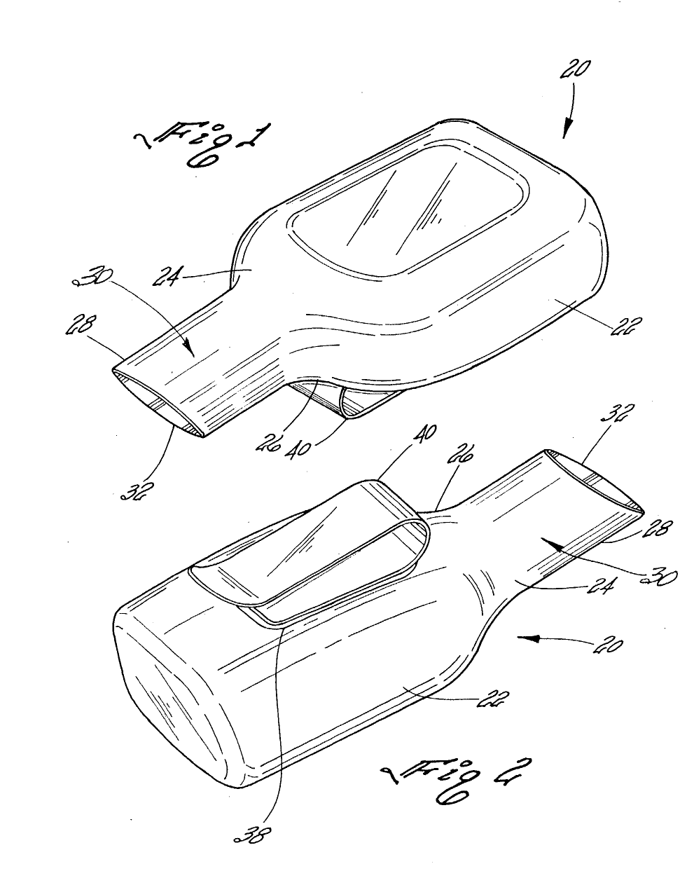

FIG. 1 is a front, left side and top perspective view of a container, portable device or apparatus, shown generally as 20, for storing and confining filling material for repairing divots on a golf course. FIGS. 2 through 8 illustrate other various views of the container, portable device or apparatus of FIG. 1. The portable device 20 is adapted to be filled with a suitable filling material, the composition of which can be customized to the needs or requirement of the golf course. The portable device is used by a golfer for immediately repairing divot made by the golfer by dispensing a quantity of filling material into and repairing a divot.

The container or portable device 20 includes a first generally extended housing 22 defining a cavity of a selected volume for confining a quantity of filling material. The housing 22 including a top member 24 having a curvilinear extending member, shown by arrow 30, for defining a dispensing passageway terminating in a dispensing opening 32 including a first end 26 and a second end 28. The curvilinear extending member 30 is cambered relative to the cavity of the housing to insure free and directive flow of the filling material. The first end 26 is configured to communicate with the cavity defined by the outer-wall of the housing 22. The second end 28 is structured or configured to define a dispensing opening 32, or orifice, positioned at a predetermined position, preferably canted, relative to the curvilinear extending member 30. Displacement of the housing 22 in a first direction urges the dispensing passageway 32 into a dispensing position wherein a portion of a quantity of filling material confined in the cavity of the housing 22 is capable of being transported through the dispensing passageway formed by the curvilinear extending member 30 of the top member 24 and out of the dispensing opening 32. In use, the filling material would be dispensed into a divot for repairing the same.

Displacement of the housing 22 in a second direction urges the dispensing passageway 32 into a storage position wherein the quantity of filling material is confined in the cavity of the housing 22.

As illustrated clearly in FIGS. 2 and 8, the housing 22 may be formed on the back and in the outer wall with a small recess 38 resulting in an indentation adapted to receive and support an attaching member. In the preferred embodiment, the attaching member may be in the form of a clip holding member 40 operatively connected to the housing 22 of the container 20. The attaching member, e.g. clip holding member 40, may be of any suitable structure to facilitate removeably mounting of the container 20 on a golf cart, golf bag or to the person of a golfer, such as a golfer's belt. In FIGS. 1, 2, and 4 through 8, the clip holding member 40 is in the form of a spring-loaded leaf or tongue member having an open end to facilitate mounting of the container 20 in a generally upright storage position. The clip holding member is sized to be attached to an electric or small gasoline engine driven Cart, push-pull golf cart or to the person of a golfer.

The small recess 38 may be eliminated and the back side of the housing may be formed into an arcuate shape, as illustrated in FIG. 16 by dashed lines 158, to facilitate easily attaching and removing the container 20 from a golf cart, golf bag or the like.

As illustrated clearly in FIGS. 4 and 7, the curvilinear extending member defined by the top member 24 has a reducing diameter extending from said first end to said second end.

As illustrated in FIGS. 1 through 8, in the preferred embodiment, the housing 22 including the top member 24 including the curvilinear extending member 30 are formed of an integral unit.

The curvilinear extending member 30 of top member 24 has a curved central axis including its central axis shown by dashed line 42 and the dispensing opening 32 is structured to position the dispensing opening 32, which is in the form of an orifice, including its center line axis shown by dashed line 44 in FIG. 7 is canted, preferably, at an acute angle alpha shown by arrow 48 relative to the curved central axis shown by dashed line 42. This angle may be from about zero degrees to about 45 degrees.

The dispensing opening 30 could be positioned to be located at any angle from: (i) having the center line axis of the dispensing opening 32 substantially co-axial to the axis of the housing; (ii) having the center line axis of the dispensing opening substantially co-axial with the curve center axis of the curvilinear extending member; or (iii) the center axis of the dispensing opening substantially perpendicular to either the axis of the cavity for the curve center axis of the curvilinear extending member.

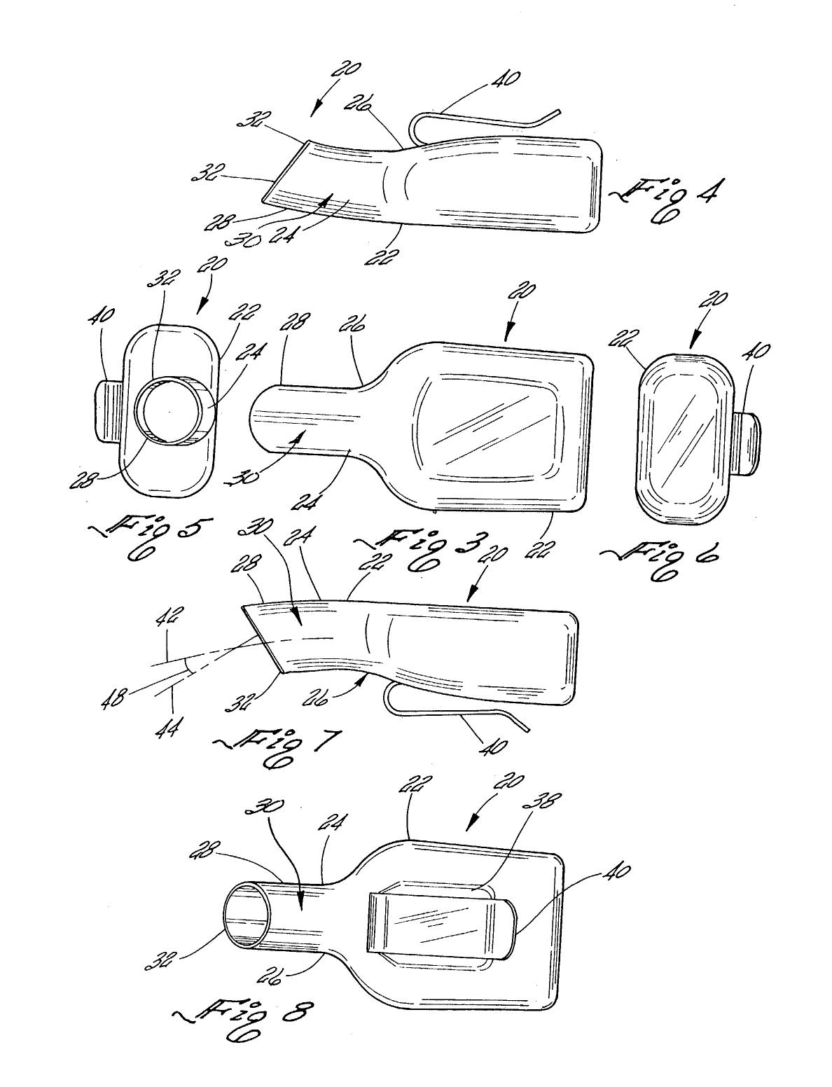

As illustrated clearly in FIG. 5, the dispensing opening 32 has a geometrically shaped cross-section, which in the preferred embodiment is generally circular-shaped. However, the geometrical shape could e any known shape, such as without limitation, oval shape, rectangular shape, oblong shape or the like.

The attaching member is operatively connected to the housing 22 and is structured to be sufficiently rigidly attached to the housing 22, so as to be capable of transporting and holding the portable device including a quantity of filling material confined therein in a storage position.

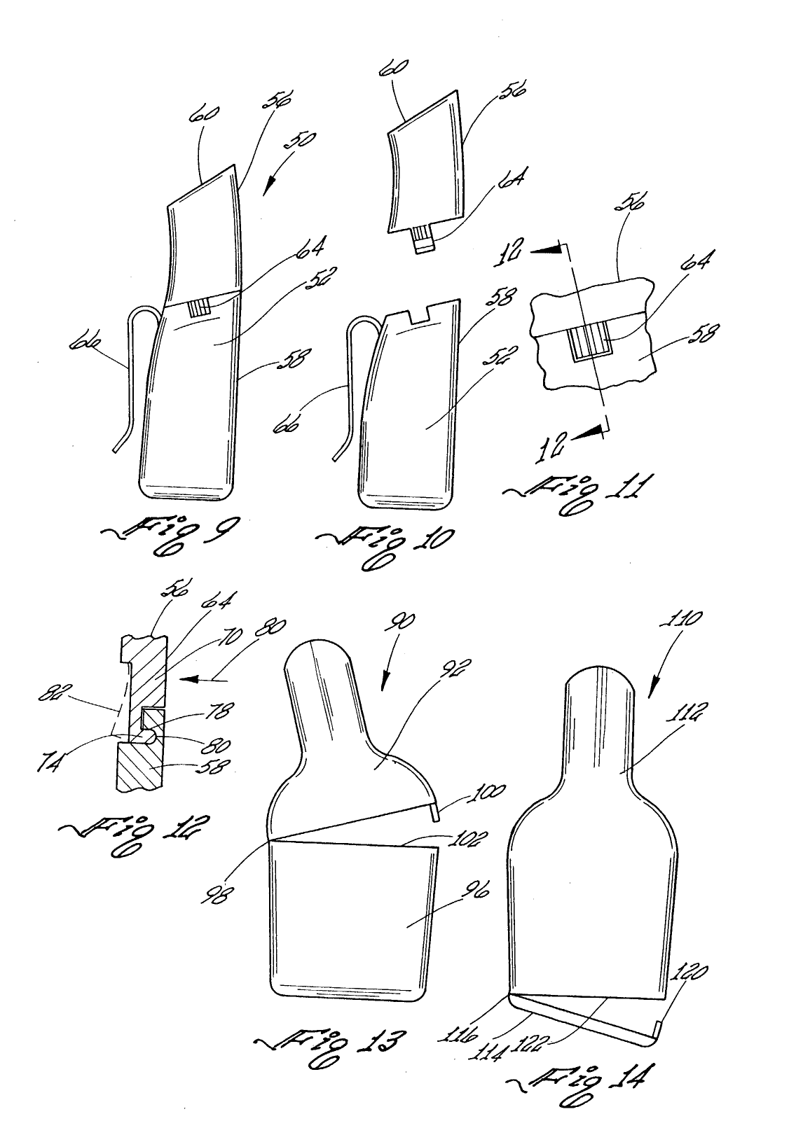

FIG. 9 illustrates, in left side elevational view, another embodiment of a container of the present invention, shown generally by arrow 50, for dispensing filling material for repairing divots on a golf course. The container 50 has a housing 52 having a top section 56 and a bottom section 58, each of which are separate elements. The top section 56 and a bottom section 58 are shown in a closed position. The top section 52 incorporates the curvilinear extending member for defining a dispensing opening 60. The top section 56 is removeably connected to the bottom section 58 of the housing 52 defining a cavity of a selected volume for confining a quantity of filling material. A biased connecting member 64 functions as a clamping member to facilitate locking and unlocking of the top section 56 to the bottom section 58.

An attaching member depicted by 66 is operatively connected to the bottom member 58.

In the left side elevational view of FIG. 10, the embodiment of the container 50 illustrated in FIG. 9 is depicted in a separated position. The biased connecting member 64 is actuated by the golfer or user to unlatch the top section 56 from the bottom section 58 and the top section 56 and bottom section 58 are then moved away from each other exposing the cavity in the housing 52. In this position, that portion of the housing 52 defining a cavity of a selected volume can be easily filled with a quantity of filling material.

In FIG. 12, the pictorial representation of the biased connecting member 64 shown in FIGS. 10 and 11 has a biased deflecting member 70 operatively connected to the top section 56. The biased deflecting member 70 has a protruding extension 74 which cooperates with a mating member 78 having a receiving slot 80 for forming a latching relationship between the protruding extension 74 and slot 80. The mating member 78 is operatively connected to the outer wall of that portion of the bottom section 58 of the housing 52 which defines a cavity of a selected volume for confining a quantity of filling material. When a force is applied to the biased deflecting member 78 in the direction depicted by arrow 80, the biased deflecting member 70 is moved into the position shown by dashed lines 82 which transports the protruding extension 74 out of the slot 80 enabling separation of the top section 56 from the bottom section 58.

After filling of the cavity of the housing 52 with the filling material, the top section 56 is urged into contact with the bottom section 58 resulting in the protruding extension 74 engaging the slot 80 to establish a locking relationship between the top section 56 and bottom section 58.

FIG. 13 illustrates yet another embodiment of a container shown generally as 90 for confining filling material for repairing divots on a golf course. The container 90 has a housing 92 having a top member in the form of a top section 94 and a bottom member in the form of a bottom section 96. The top section 92 and bottom section 96 are pivotally connected to rotate about a pivot 98 from a closed position to an open position to provide access to and for filling the cavity with filling material. When the top section 92 and bottom section 94 are moved back into their closed position, a latching member 100 is moved onto its latched position cooperating with a connecting member 102 formed in the bottom section 96. In the latched closed position, the housing 92 confines the filling material in the cavity.

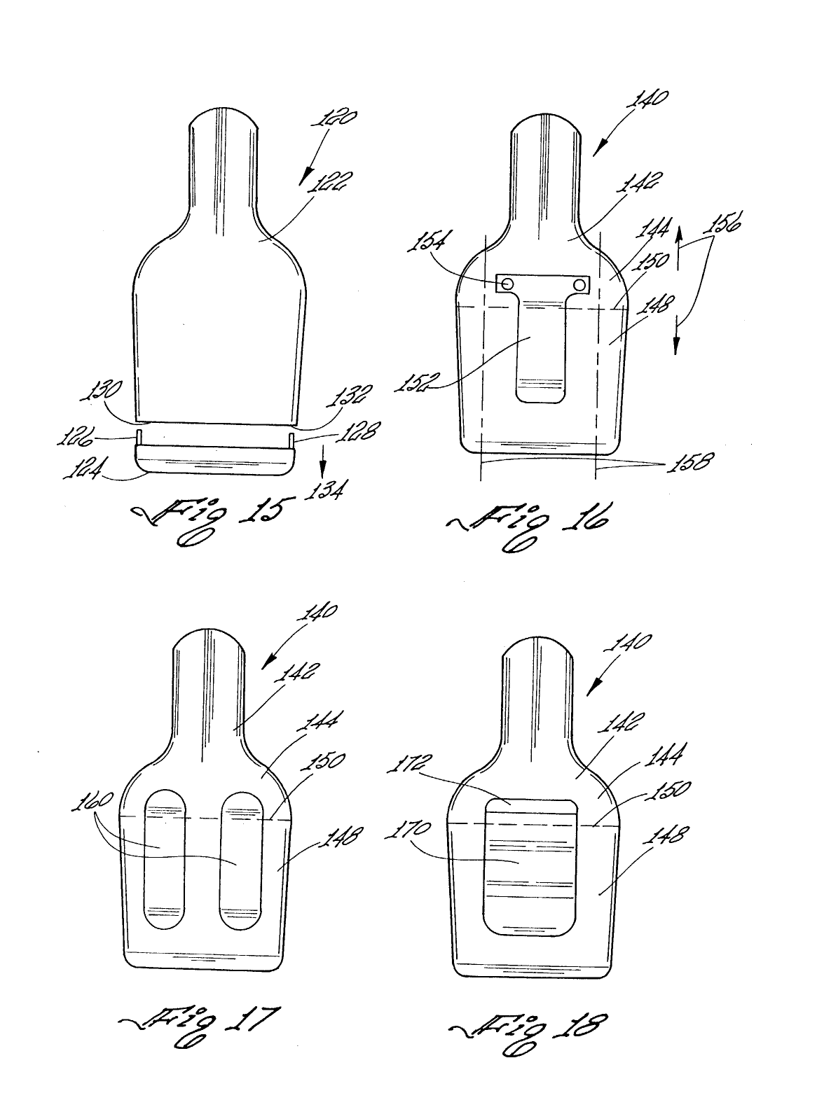

FIG. 14 illustrates still yet another embodiment of a container 110 for confining filling material for repairing divots on a golf course wherein the container 110 has a housing 112 including the portion of the housing defining a cavity of a selected volume for confining a quantity of material for filling a divot and including the curvilinear extending member and dispensing opening defines a housing section and wherein a bottom planar section 114 is a separate element which is pivotally connected to rotate about a pivot 116 relative to the housing 112 from a closed position to an open position. In the open position, access is provided to the cavity and for filling the cavity within the housing 112 with filling material. The bottom planar section 114 is moved back into its closed position to move a latching member 120 into its latched position cooperating with receiving member 122 formed in the housing 112 to confine the filling material in the cavity.

As such, in its broadest aspect, the housing section and the bottom planar section have cooperating latching members to enable the housing section and bottom planar section to be moved relative to each other from a closed latched position to an open unlatched position to provide access to the cavity for filling the cavity with a quantity of material for filling a divot. The housing section and the bottom planar section are configured to be towards each other to engage the latching members a closed latched position forming a closed position to confine a quantity of material for filling a divot in the cavity.

FIG. 15 is yet still another embodiment of a container 120 for dispensing filling material for repairing divots on a golf course. The container 120 includes a housing section 122 and a separate bottom planar section 124 which is adapted to be unlatched on two sides using latching members 126 and 128 which cooperate with latching receiving members 130 and 132, respectively, formed in the housing section 122. By applying a separation force to the bottom planar section 124 in the direction shown by arrow 134, the force separates bottom planar section 124 from the housing section 122. As a result, the latching members 130 and 132 unlatch from the latching receiving members 130 and 132 thereby moving the bottom planar section 124 from a latched closed position to an unlatched open position to provide access to and for filling the cavity of the housing section 122 with filling material. When the separate bottom planar section 124 is moved back into its closed position urging the latching members 130 and 132 into the latching receiving members 130 and 132, the filling material is confined in the cavity of the housing section 122.

FIGS. 16, 17 and 18 illustrate yet another embodiment of a container 140 having a housing 142 formed of a separate top section 144 and a separate bottom section 148 which are joined at the center of the housing 142 by a snap connecting member shown by dashed line 150, of a form known to those skilled in the art, for removeably connecting the top section 144 to the bottom section 148. FIGS. 16, 17 and 18 illustrate the container 140 with the housing 142 top section 144 and bottom section 148 being in a closed position.

By applying a separation force in the direction shown by arrows 156, the top section 144 is snapped away from the bottom section 148 exposing the cavity in housing 142. When in the open position, the cavity in housing 142 can be filled with a filling material and then the top section 142 is urged into latching contact with the bottom section 148 causing the snap connecting member to hold the housing 142 in a closed position confining the filling material in the cavity of the housing 142.

In FIG. 16, it is envisioned that the back of the housing 142 including the appropriate portions of the top section 142 and bottom section 144 may be formed into an arcuate shape between the areas shown by dashed lines 158 to facilitate easily attaching and removing the container 140 from a golf cart, golf bag or the like.

In FIG. 16, the container 140 has an attaching member in the form of a spring loaded clip member 152 which is connected to the back of the top section 142 by fastening members 154.

In FIG. 17, the container 140 has an attaching member having a dual element clip holding member 160 which is operatively connected, e.g. by means of an adhesive as is well known to persons skilled in the art, to the back side of top section 144.

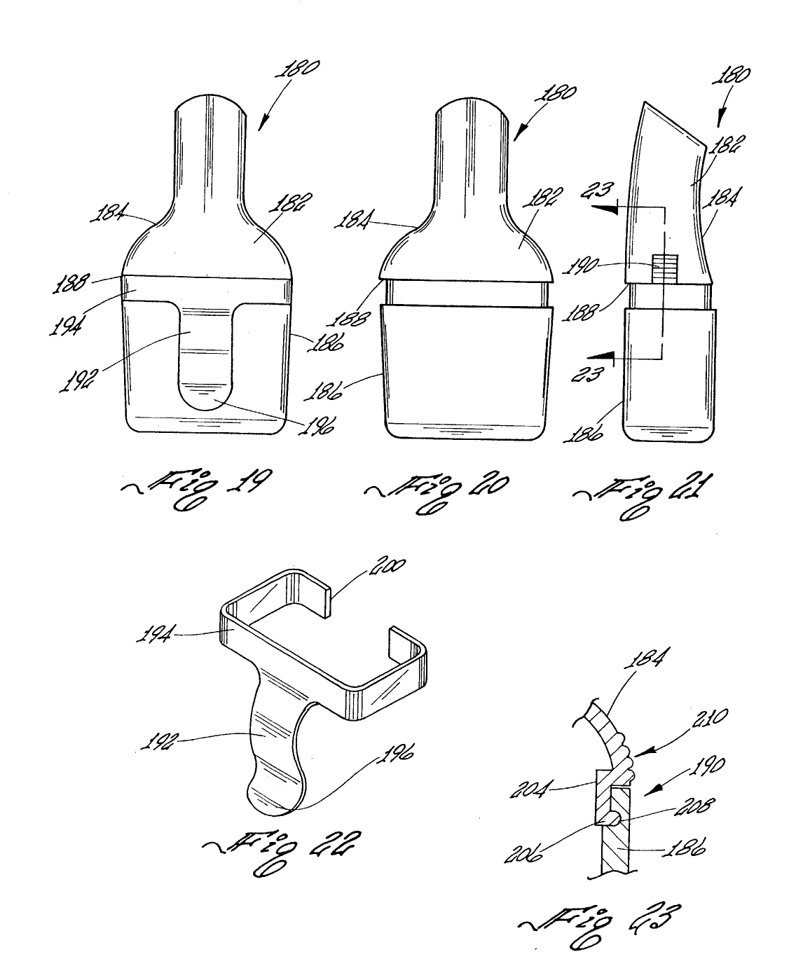

In FIG. 18, the container 140 has an attaching member having a single, wide element clip holding member 170 which is operatively connected, e.g. by means of an adhesive as is well known to persons skilled in the art, to the back side of top section 144. The clip holding member 170 has a top clip holding section 172 to facilitate rigidly attaching of the clip holding member 170 to the top section 142.

FIGS. 19, 20 and 21 illustrate still yet another embodiment of a container 180 having a housing 182 for filling material for repairing divots on a golf course. The housing 182 has a top section 184 and a bottom section 186 that are held in a latching relationship by a biased connecting member 190 located one on each side of the housing 182. The housing 182 has a circumferential slot 186 formed in the bottom section 186 for receiving a shaped elongated support having a clip holding member 192. The shaped elongated support having a clip holding member 192 has an elongated support member 194 and an integral clip holding member in the form of a spring-loaded tongue 196. This is shown in greater detail in FIG. 22.

The front elevational view of the housing 182 of FIG. 20 shows the details of the circumferential slot 186 formed in the outer wall of the bottom section 186 of housing 182.

The right side elevational view of the housing 182 of FIG. 21 illustrates that the top section 184 of the housing 182 has a biased connecting member 190 formed therein and located above the circumferential slot 188. This is shown in greater detail in FIG. 23;

FIG. 22 is a front, top and right side perspective view of the shaped elongated support having a clip holding member 192. The shaped elongated support having a clip holding member 192 has an elongated support member 194 and an integral clip holding member in the form of a spring-loaded tongue 196. The portion of the elongated support member 194 adapted to be located on the front side of the housing 182 has an opening 200 formed therein. Opening 200 enables the elongated support member 194 to be flexed or displaced apart so as to be inserted into the circumferential slot 188 depicted in FIGS. 19, 20 and 21. After insertion, the spring action of the elongated support member 194 urges the elongated support member 194 snuggly and rigidly into the circumferential slot.

FIG. 22 is pictorial representation of the biased connecting member 190 shown in FIG. 21. The biased connecting member 190 shown in FIG. 23 has a biased deflecting member 204 operatively connected to the top section 184. The biased deflecting member 204 has a protruding extension 206 which cooperates with a mating member having a receiving slot 208 formed in the bottom section 184. As a result a latching relationship is formed between the protruding extension 206 and receiving slot 208. The mating member having a receiving slot 208 which is operatively connected to the outer wall of that portion of the bottom member 186 of the housing 182 which defines a cavity of a selected volume for confining a quantity of filling material.

When a force is applied to the biased deflecting member 190 in the direction depicted by arrow 210, the biased deflecting member 204 is moved out of its latching relationship with the receiving slot 208 enabling separation of the top section 182 from the bottom section 184.

The container or portable device disclosed herein can be used in a divot repair system for a golf course. The system would comprise a source of filling material for filling divots, a plurality of portable devices, containers or apparatus for dispensing a quantity of filling material wherein each portable device, container or apparatus would comprise a first generally extended housing defining a cavity of a selected volume for confining a quantity of filling material wherein the housing would include a top member having a curvilinear extending member for defining a dispensing passageway including a first end and a second end and wherein the first end is structured to communicate with the cavity and the second end is configured to define a dispensing opening cambered relative to the cavity such that displacement of the housing in a first direction urges the dispensing passageway into a dispensing position wherein a portion of a quantity of filling material confined in the cavity is capable of being transported through the dispensing passageway and out of the dispensing opening into a divot and displacement of the housing in a second direction urges the dispensing passageway into a storage position wherein a quantity of filling material is confined in the cavity and wherein said portable device would include an attaching member to facilitate removeably supporting the portable device when filled with a filling material in a storage position on at least one of a golf cart, golf bag or to the person of a golfer, a distribution station positioned at a location where a golfer commencing playing of a game of golf wherein a golfer can pick-up a filled portable container for use during a play of golf; at least one filling station positioned at a located intermediate the area of golf play wherein a golfer can replenish the filling material in the portable container; and a return station positioned at a location where a golfer ending playing a game of golf can return the portable container used during a play of golf.

In addition, a method for filling a divot using the portable device or container of the present invention is taught by the present invention.

The method comprises the steps of

filling with a filling material a portable device for dispensing a quantity of filling material wherein each portable device would comprise a first generally extended housing defining a cavity of a selected volume for confining a quantity of filling material wherein the housing would include a top member having a curvilinear extending member for defining a dispensing passageway including a first end and a second end and wherein the first end is structured to communicate with the cavity and the second end is structured to define a dispensing opening canted at an angle relative to the cavity such that displacement of the housing in a first direction urges the dispensing passageway into a dispensing position wherein a portion of a quantity of filling material confined in the cavity is capable of being transported through the dispensing passageway and out of the dispensing opening and displacement of the housing in a second direction urges the dispensing passageway into a storage position wherein a quantity of filling material is confined in the cavity and wherein said portable device would include an attaching member to facilitate removeably supporting the portable device when filled with a filling material in a storage position on at least one of a golf cart, golf bag or to the person of a golfer;

when a divot is to be repaired by a golfer, displacing the housing in a first direction to urge the dispensing passageway into a dispensing position wherein a portion of a quantity of filling material confined in the cavity is transported through the dispensing passageway and out of the dispensing opening into a divot to repair the same; and

when a selected quantity of filling material has been dispensed to repair the divot, displacing the housing in a second direction to urge the dispensing passageway into a storage position wherein the quantity of filling material is confined in the cavity.

The method may further comprise the step of

attaching in a storage position with the attaching member the portable device to at least one of a golf cart, golf bag or person of a golfer.

The method may further comprise the step of

filling the portable device with filling material at a filling station positioned intermediate the play of golf.

The portable device, container or apparatus of the present invention can be fabricated as an integral unit as discussed above with respect to FIGS. 1 through 8. The container housing may be fabricated from any material known to any persons skilled in the art, such as, for example, without limitation of plastic material, PBC, polyethylene, vinyl, foam, thermoforming material or the like. The attaching members can likewise be fabricated from a tufted, durable plastic material or the like or can be fabricated from aluminum, steel or other metal material.

The container of the present invention can be formed, manufactured or fabricated using known manufacturing techniques, such as, for example, by injection molding.

The materials and methods for manufacturing or fabricating the container housing and attaching members are well-known to persons skilled in the art and it is envisioned that all such materials, methods and processes capable of being used for practicing this invention are within the scope of the disclosure and teachings thereof.

It is recognized that changes, variations and modifications, particularly by those skilled in the art, made be made to the container or portable device of this invention. All such variations and modifications should be considered to fall within the scope of the invention as broadly hereinbefore described and as claimed hereafter.

What is claimed is:

1. A portable device for dispensing a quantity of filling material comprising
a first generally extended housing defining a cavity of a selected volume for confining a quantity of filling material, said housing including a top member having a curvilinear extending member for defining a dispensing passageway including a first end and a second end, said first end being structured to communicate with said cavity and said second end being structured to define a dispensing opening positioned in a predetermined position relative to the cavity such that displacement of the housing in a first direction urges the dispensing passageway into a dispensing position wherein a portion of a quantity of filling material confined in the cavity is capable of being transported through the dispensing passageway and out of the dispensing opening and displacement of the housing in a second direction urges the dispensing passageway into a storage position wherein a quantity of filling material is confined in the cavity.

2. The portable device of claim 1 wherein said curvilinear extending member has a reducing diameter extending from said first end to said second end.

3. The portable device of claim 1 wherein said curvilinear extending member has an elongated axis and terminates in a dispensing opening which is canted relative to the elongated axis of said curvilinear extending member.

4. The portable device of claim 1 wherein said housing, top member including said curvilinear extending member are formed of an integral unit.

5. The portable device of claim 1 wherein said housing includes a back having a small recess formed therein.

6. The portable device of claim 1 further comprising
an attaching member operatively connected to the housing and structured to transport the portable device including a quantity of filling material confined therein in a storage position.

7. The portable device of claim 6 wherein said housing has a back and wherein the attaching member is in the form of a spring-loaded clip member operatively connected to the back.

8. The portable device of claim 1 wherein said curvilinear extending member has a curved central axis and said dispensing opening has a center line axis and the dispensing opening is configured to position the dispensing opening center line axis at an acute angle relative to the curved central axis.

9. The portable device of claim 1 wherein the dispensing opening has a geometrically shaped cross-section.

10. The portable device of claim 9 wherein the dispensing opening geometrically shaped cross-section is substantially a circular cross-section.

11. Apparatus for dispensing a filling material for repairing a divot comprising
a first generally extended housing having a central axis, said housing including outer walls, a bottom member and a top member which define a cavity of a selected volume structured to confine a quantity of filling material for repairing a divot, said bottom member being operatively attached to the outer walls to define a bottom for the cavity, said top member including a curvilinear extending member for defining a dispensing passageway having a first end and a second end wherein said first end communicates with the outer walls defining said cavity and said second end defines a dispensing opening having its center line axis positioned relative to the cavity such that displacement of the bottom of said housing in a first direction urges the center line axis and dispensing passageway into a dispensing position wherein a portion of a quantity of filling material for repairing a divot confined in the cavity is capable of being transported through the dispensing passageway and the dispensing opening into a divot and displacement of the bottom of said housing in a second direction urges the center line axis and dispensing passageway into a storage position wherein a quantity of filling material for repairing a divot is confined in the cavity.

12. The apparatus of claim 11 wherein said curvilinear extending member has a reducing diameter extending from said first end to said second end.

13. The apparatus of claim 11 wherein said housing, bottom member and top member including said curvilinear extending member are formed of an integral unit.

14. The apparatus of claim 10 wherein said housing includes back having a small recess formed therein.

15. The apparatus of claim 11 further comprising
an attaching member operatively connected to the housing and structured to be removeably attached to at least one of a golf cart, a golf bag and to the person of a golfer for supporting the apparatus including a quantity of filling material confined therein in a storage position.

16. The apparatus of claim 15 wherein said housing has a back and wherein the attaching member is in the form of a spring-loaded clip member operatively connected to the back.

17. The apparatus of claim 11 wherein said curvilinear extending member has a curved central axis and said dispensing opening has a center line axis and the dispensing opening is configured to position the dispensing opening center line axis at an acute angle relative to the curved central axis.

18. The apparatus of claim 11 wherein the dispensing opening has a geometrically shaped cross-section.

19. The apparatus of claim 18 wherein the dispensing opening geometrically shaped cross-section is substantially a circular cross-section.

20. The apparatus of claim 11 wherein said housing has a bottom section and a top section, said bottom section defining a cavity of a selected volume for confining a quantity of filling material for repairing a divot which is removeably connected to the top section including the first end of said curvilinear extending member and dispensing opening to enable the bottom section and top section to be moved relative to each other from a closed position to an open position to provide access to the cavity for filling the cavity with a quantity of filling material for repairing a divot, said top section and said bottom section being configured to be moved back into its closed position to confine a quantity of filling material for repairing a divot in the cavity.

21. The apparatus of claim 20 wherein the bottom section is removeably connected to the top section through a biased connecting member wherein the biased connecting member is depressed to override the bias to disconnect the bottom section from the top section to enable the top section to be moved away from the bottom section in a closed position to an open position to provide access to the cavity and when said top section is urged into engagement with the bottom section the bias of the biased connecting member urges the biased connecting member into a latching relationship connecting the top section to the bottom section in a closed position to confine the filling material in the cavity.

22. The apparatus of claim 11 wherein a bottom section of the housing is pivotally connected at a pivot to the top section of the housing to enable the top section and bottom section to rotate about the pivot from a closed position to an open position to provide access to the cavity for filling the cavity with a quantity of material for filling a divot, said top section and said bottom section being configured to be rotated about the pivot back into a latched closed position to confine a quantity of filling material for repairing a divot in the cavity.

23. The apparatus of claim 11 wherein the portion of the housing defining a cavity of a selected volume for confining a quantity of filling material for repairing a divot including said curvilinear extending member and dispensing opening define a separate housing section which is pivotally connected at a pivot to a separate bottom planar section to enable the housing section and bottom section to rotate about the pivot relative to each other from a closed position to an open position to provide access to the cavity for filling the cavity with a quantity of filling material for repairing a divot, said housing section and said bottom planar section being configured to be rotated about the pivot back into a closed position to confine a quantity of filling material for repairing a divot in the cavity.

24. The apparatus of claim 11 wherein the portion of the housing defining a cavity of a selected volume for confining a quantity of filling material for repairing a divot including said curvilinear extending member and dispensing opening define a separate housing section and a separate bottom planar section, said housing section and said bottom planar section having cooperating latching members to enable the housing section and bottom planar section to be moved relative to each other from a latched closed position to an unlatched open position to provide access to the cavity for filling the cavity with a quantity of filling material for repairing a divot, said housing section and said bottom planar section being configured so as to be urged towards each other to engage the latching members forming a latched closed position to confine a quantity of filling material for repairing a divot in the cavity.

25. The apparatus of claim 20 wherein said bottom section has a circumferential slot for receiving an attaching member.

26. The apparatus of claim 25 wherein said circumferential slot is configured to receive and support an elongated support having a clip holding member.

27. The apparatus of claim 26 further comprising
an elongated support having a clip holding member.

28. The apparatus of claim 11 wherein said attaching member is in the form of a spring loaded clip member.

29. The apparatus of claim 28 wherein the housing has a back and said spring loaded clip member is connected to the back of the housing by at least one fastening member.

30. The apparatus of claim 11 wherein said attaching member is in the form of a dual element clip holding member.

31. The apparatus of claim 11 wherein said attaching member is in the form of a single, wide element clip holding member.

32. A system comprising:
a source of filling material for filling divots;
a plurality of portable device for dispensing a quantity of filling material wherein each portable device would comprise a first generally extended housing defining a cavity of a selected volume for confining a quantity of filling material wherein the housing would include a top member having a curvilinear extending member for defining a dispensing passageway including a first end and a second end and wherein the first end is structured to communicate with the cavity and the second end is configured to define a dispensing opening relative to the cavity such that displacement of the housing in a first direction urges the dispensing passageway into a dispensing position wherein a portion of a quantity of filling material confined in the cavity is capable of being transported through the dispensing passageway and out of the dispensing opening and displacement of the housing in a second direction urges the dispensing passageway into a storage position wherein a quantity of filling material is confined in the cavity and wherein said portable device would include an attaching member to facilitate removeably supporting the portable device when filled with a filling material in a storage position on at least one of a golf cart, golf bag or person of a golfer;
a distribution station positioned at a location where a golfer commencing playing a game of golf wherein a golfer can pick-up a filled portable container for use during a play of golf; and
at least one filling station positioned at a located in an intermediate area of golf play wherein a golfer can replenish the filling material in the portable container; and a return station positioned at a location where a golfer ending playing a game of golf wherein a golfer can return the portable container used during a play of golf.

33. The system of claim 32 wherein said a source of filling material may comprise at least one of sand, grass seed and a soil supplement.

34. The system of claim 31 further comprising
a return station positioned at a location where a golfer ending playing a game of golf can return the portable container used during a play of golf.

35. A method for repairing a divot comprising the steps of:
filling with a filling material a portable device for dispensing a quantity of filling material wherein each portable device would comprise a first generally extended housing defining a cavity of a selected volume for confining a quantity of filling material wherein the housing would include a top member having a curvilinear extending member for defining a dispensing passageway including a first end and a second end and wherein the first end is configured to communicate with the cavity and the second end is configured to define a dispensing opening cambered relative to the cavity such that displacement of the housing in a first direction urges the dispensing passageway into a dispensing position wherein a portion of a quantity of filling material confined in the cavity is capable of being transported through the dispensing passageway and out of the dispensing opening and displacement of the housing in a second direction urges the dispensing passageway into a storage position wherein a quantity of dispensable filling material is confined in the cavity and wherein said portable device would include an attaching member to facilitate removeably supporting the portable device when filled with a filling material in a storage position on at least one of a golf cart, golf bag or person of a golfer;
when a divot is to be repaired by a golfer, displacing the housing in a first direction to urge the dispensing passageway into a dispensing position wherein a portion of a quantity of filling material confined in the cavity is transported through the dispensing passageway and out of the dispensing opening into a divot to repair the same; and
when a selected quantity of filling material has been dispensed to repair the divot, displacing the housing in a second direction to urge the dispensing passageway into a storage position wherein the quantity of filling material is confined in the cavity.

36. The method of claim 35 further comprising the step of:
attaching in a storage position with the attaching member the portable device to at least one of a golf cart, golf bag or person of a golfer.

37. The method of claim 35 further comprising the step of
filling the portable device with filling material at a filling station positioned intermediate the play of

38. The system of claim 35 wherein the step of filling include using a source of filling material which comprises at least one of sand, grass seed and a soil supplement.
